(19) United States
(12) Patent Application Publication
(10) Pub. No.: US 2023/0217895 A1
(43) Pub. Date: Jul. 13, 2023

(54) MICROLAYERING PEST CONTROL SYSTEM

(71) Applicant: John Greeson, Roswell, NM (US)

(72) Inventor: John Greeson, Roswell, NM (US)

(21) Appl. No.: 18/094,603

(22) Filed: Jan. 9, 2023

Related U.S. Application Data
(60) Provisional application No. 63/297,358, filed on Jan. 7, 2022.

(51) Int. Cl. A01K 13/00

(52) U.S. Cl. CPC A01K 13/003

(57) ABSTRACT

A method of, and apparatus for, controlling pests on an animal, comprising combining generally immiscible ingredients, maintaining the ingredients in a combined state by controlling the fluids pathway so that the immiscible ingredients are contained together in correct proportions under pressure, and discharging selected desired quantities of the combined ingredients through a nozzle that imparts turbulence in one or more applications on the animal.

### CROSS-REFERENCE TO RELATED APPLICATIONS

This application claims priority to and the benefit of the filing of U.S. Provisional Patent Application Ser. No. 63/297,358, filed on Jan. 7, 2022, and the specifications and claims thereof are incorporated herein by reference. This application is related to U.S. Pat. No. 8,438,996, issued on May 14, 2013, and the specification and claims thereof are incorporated herein by reference.

### STATEMENT REGARDING FEDERALLY SPONSORED RESEARCH OR DEVELOPMENT

Not Applicable.

### NAMES OF PARTIES TO JOINT RESEARCH AGREEMENT

Not Applicable.

### REFERENCE TO A SEQUENCE LISTING, A TABLE, OR A COMPUTER PROGRAM LISTING COMPACT DISC APPENDIX

Not Applicable.

### STATEMENT REGARDING PRIOR DISCLOSURES BY THE INVENTOR OR A JOINT INVENTOR

Not Applicable.

### BACKGROUND OF THE INVENTION

### Field of the Invention (Technical Field)

The present invention relates to an improved microlayering pest control system.

### Description of Related Art

U.S. Pat. No. 8,438,996 discloses a microlayering pest control system. Unfortunately, this system had a tendency to inject oil/insecticide into the water stream via a high-speed pump that would shatter and induce a slight homogenization. This has been discovered to be an issue with the wax component of the oil falling out and building up in the distribution lines.

### BRIEF SUMMARY OF THE INVENTION

The present invention is of a method of controlling pests on an animal, the method comprising: combining generally immiscible ingredients; maintaining the ingredients in a combined state by controlling the fluids pathway so that the immiscible ingredients are contained together in correct proportions under pressure; and discharging selected desired quantities of the combined ingredients through a nozzle that imparts turbulence in one or more applications on the animal. In an embodiment, the immiscible ingredients comprise water and oil. Maintaining preferably comprises maintaining the water and oil in a combined state by controlling the fluids pathway so that the immiscible ingredients are contained together in a proportion under pressure of at least two to one by volume, and most preferably about twenty-five to one by volume. The maintaining step preferably comprises employing one or more gravity traps in the fluids pathway in conjunction with all but a last nozzle.

The invention is also of an apparatus for controlling pests on an animal, comprising means for combining generally immiscible ingredients, means for maintaining the ingredients in a combined state by controlling the fluids pathway so that the immiscible ingredients are contained together in correct proportions under pressure, and means for discharging selected desired quantities of the combined ingredients through a nozzle that imparts turbulence in one or more applications on the animal. In an embodiment, the immiscible ingredients comprise water and oil. The maintaining means preferably maintains the water and oil in a combined state by controlling the fluids pathway so that the immiscible ingredients are contained together in a proportion under pressure of at least two to one by volume, and most preferably about twenty-five to one by volume. The maintaining means preferably comprises one or more gravity traps in the fluids pathway in conjunction with all but a last nozzle.

Further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE VIEWS OF THE DRAWINGS

The accompanying drawings, which are incorporated into and form a part of the specification, illustrate one or more embodiments of the present invention and, together with the description, serve to explain the principles of the invention. In the drawings:

FIG. 1 illustrates the initial mixing components of a microlayering pest control system;

FIG. 2 illustrates a modification of the distribution line for a two-nozzle distribution line employing a gravity trap at the first nozzle; and

FIG. 3 further illustrates the apparatus of the invention, which can have multiple nozzles with gravity traps.

### DETAILED DESCRIPTION OF THE INVENTION

The present invention provides the advantages of the microlayering pest control system that avoids the wax fallout and so greatly enhances reliability of the system. The present invention is illustrated and more fully elucidated in drawings.

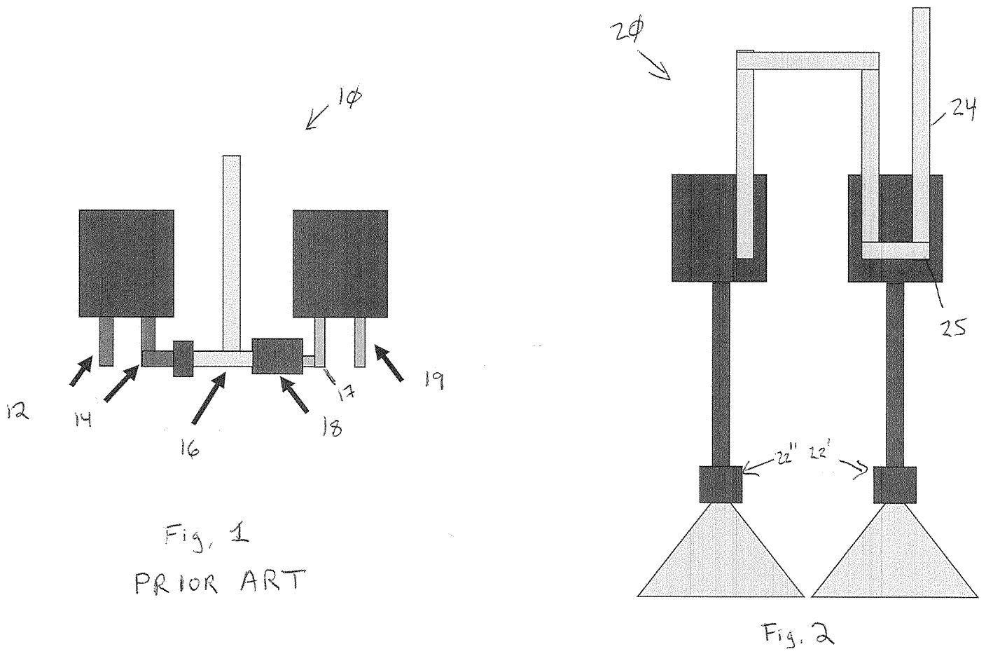

FIG. 1 illustrates the initial mixing components of a microlayering pest control system, comprising water suction 12 to a pump, discharge 14 from the pump, oil/chemical suction 19 to a second pump, oil/chemical discharge 17 from the second pump, check valve 18, and a junction 16 at which the discharged fluids are combined under pressure.

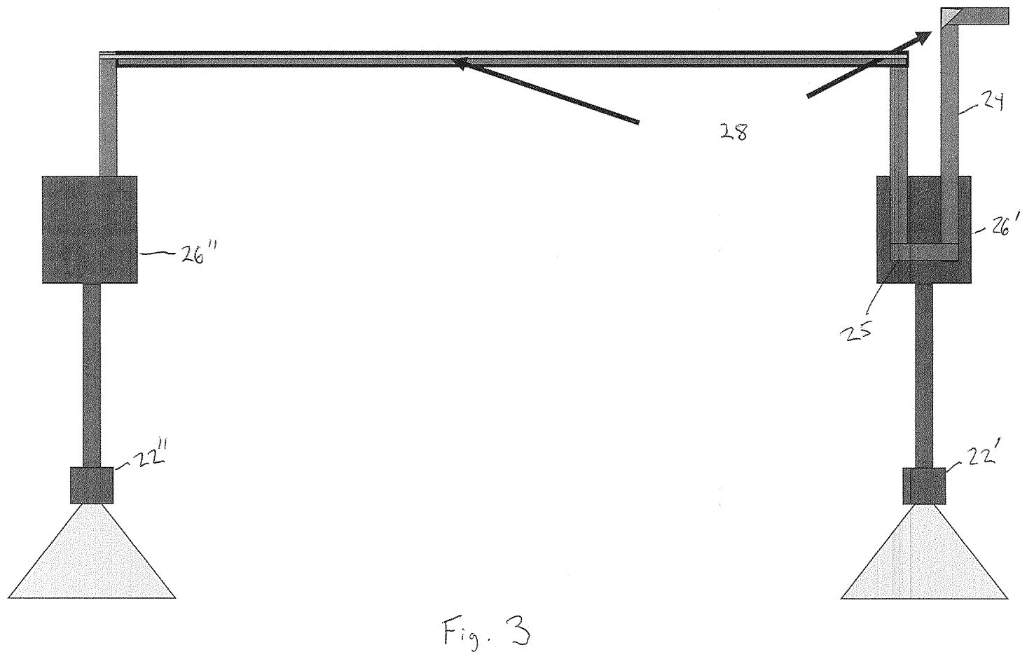

FIG. 2 illustrates an inventive modification 20 of the distribution line 24 for a two-nozzle distribution line employing a gravity trap 25 at the first nozzle 22′, while the second nozzle 22″ does not have such a gravity trap.

FIG. 3 further illustrates the apparatus of the invention, which can have multiple lanes 26′ with corresponding nozzles 22′ with gravity traps 25. The final lane 26″ and final nozzle 22″ preferably do not employ a gravity trap. Note that the oil (and entrapped chemical) tend to float to the highest points 28 of the distribution line.

Maintaining the flow of water at about a volume ratio of about two to one or greater (most preferably about twenty-five to one) compared to oil flow allows boundary layer attraction between particles to carry everything along with turbulence and velocity thereby created. A gravity trap further worked to keep the correct percentage of oil/insecticide in the flow to the additional lanes of the system.

Note that in the specification and claims, “about” or “approximately” means within ten percent (10%) of the numerical amount cited.

Although the invention has been described in detail with particular reference to these preferred embodiments, other embodiments can achieve the same results. Variations and modifications of the present invention will be obvious to those skilled in the art and it is intended to cover all such modifications and equivalents. The entire disclosures of all references, applications, patents, and publications cited above and/or in the attachments, and of the corresponding application(s), are hereby incorporated by reference.

What is claimed is:

1. A method of controlling pests on an animal, the method comprising the steps of:
combining generally immiscible ingredients;
maintaining the ingredients in a combined state by controlling the fluids pathway so that the immiscible ingredients are contained together in correct proportions under pressure; and
discharging selected desired quantities of the combined ingredients through one or more nozzles that impart turbulence in one or more applications on the animal.

2. The method of claim 1 wherein the immiscible ingredients comprise water and oil.

3. The method of claim 2 wherein the maintaining step comprises maintaining the water and oil in a combined state by controlling the fluids pathway so that the immiscible ingredients are contained together in a proportion under pressure of at least two to one by volume.

4. The method of claim 3 wherein the maintaining step comprises maintaining the water and oil in a combined state by controlling the fluids pathway so that the immiscible ingredients are contained together in a proportion under pressure of about twenty-five to one by volume.

5. The method of claim 1 wherein the maintaining step comprises employing one or more gravity traps in the fluids pathway in conjunction with all but a last nozzle.

6. An apparatus for controlling pests on an animal, comprising means for combining generally immiscible ingredients, means for maintaining the ingredients in a combined state by controlling the fluids pathway so that the immiscible ingredients are contained together in correct proportions under pressure, and means for discharging selected desired quantities of the combined ingredients through one or more nozzles that impart turbulence in one or more applications on the animal.

7. The apparatus of claim 6 wherein the immiscible ingredients comprise water and oil.

8. The apparatus of claim 7 wherein the maintaining means maintains the water and oil in a combined state by controlling the fluids pathway so that the immiscible ingredients are contained together in a proportion under pressure of at least two to one by volume.

9. The apparatus of claim 8 wherein the maintaining means maintains the water and oil in a combined state by controlling the fluids pathway so that the immiscible ingredients are contained together in a proportion under pressure of about twenty-five to one by volume.

10. The apparatus of claim 6 wherein the maintaining means comprises one or more gravity traps in the fluids pathway in conjunction with all but a last nozzle.
